(19) United States
(12) Patent Application Publication
(10) Pub. No.: US 2007/0290920 A1
(43) Pub. Date: Dec. 20, 2007

(54) Wireless communication apparatus method and system for vehicle

(75) Inventors: Tatsuya Shintai, Chita-gun (JP); Kouji Shinoda, Farmington Hills, MI (US)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/818,565

(22) Filed: Jun. 14, 2007

(30) Foreign Application Priority Data
Jun. 20, 2006 (JP) 2006-170084

(51) Int. Cl. G01S 5/14

(52) U.S. Cl. 342/357.09; 342/357.15

(57) ABSTRACT

A wireless communication system for a vehicle includes a navigation apparatus and an emergency report apparatus. When a vehicle accessory switch is in an on position, the navigation apparatus performs a GPS synchronization to receive assistance data including almanac and ephemeris from a GPS satellite and outputs the assistance data to the emergency report apparatus. The emergency report apparatus stores the assistance data in a memory. In a case where an abnormal condition of the vehicle occurs when the accessory switch is in an off position, the emergency report apparatus determines whether the assistance data stored in the memory is valid for a GPS positioning. When the assistance data is valid, the emergency report apparatus starts to perform the GPS positioning to calculate a current location of the vehicle by using the assistance data stored in the memory.

### CROSS REFERENCE TO RELATED APPLICATION

This application is based on and incorporates herein by reference Japanese Patent Application No. 2006-170084 filed on Jun. 20, 2006.

### FIELD OF THE INVENTION

The present invention relates to a wireless communication apparatus, method and system for transmitting location data indicative of a current location of a vehicle to a predetermined destination.

### BACKGROUND OF THE INVENTION

As disclosed in, for example, JP-A-2004-180218, an in-vehicle wireless communication apparatus has been proposed that is used in combination with a car navigation apparatus having a first global positioning system (GPS) receiver and has a second GPS receiver.

In the car navigation apparatus, the first GPS receiver continuously performs a GPS synchronization to receive assistance data (i.e., almanac and ephemeris) from a GPS satellite, when an accessory (ACC) switch of a vehicle is on. In other words, the first GPS receiver does not perform the GPS synchronization when the ACC switch is off. The first GPS receiver performs a GPS positioning to calculate a current position of the vehicle by using the assistance data.

The in-vehicle wireless communication apparatus may be an emergency report apparatus that operates when the ACC switch is off. The emergency report apparatus transmits an emergency message containing the current position of the vehicle to a service center (e.g., police station, or a security company), when an attempt to steal or damage the vehicle is detected by a vibration sensor, a door sensor, or the like. In the emergency report apparatus, the second GPS receiver performs the GPS positioning only when the attempt is detected. The assistance data required for the GPS positioning is valid only for a certain period of time, and it is rare that the attempt to steal or damage the vehicle is made. Therefore, when the attempt is made, the second GPS receiver always needs to perform the GPS synchronization to receive the assistance data from the GPS satellite. In short, every time when the attempt is made, a cold start of the second GPS receiver is required. Therefore, generally, tens of seconds to tens of minutes passes, before the second GPS receiver completes the GPS positioning. As a result, the transmission of the emergency message to the service center is delayed so that a chance of catching a person who made the attempt is reduced.

One approach to this problem is to cause the second GPS receiver to continuously perform the GPS synchronization when the ACC switch is off. However, this approach increases power consumption of a vehicle battery so that the battery may go dead.

Another approach to this problem is to use network assistance in which the assistance data can be received from a network server. However, this approach requires an infrastructure for the network assistance.

### SUMMARY OF THE INVENTION

In view of the above-described problem, it is an object of the present invention to provide a wireless communication apparatus, method and system, in which the wireless communication apparatus starts a GPS portioning to calculate a current location of a vehicle and transmits location data indicative of the current location of the vehicle to a predetermined destination, as soon as the location data is required.

A wireless communication system for a vehicle includes a navigation apparatus and a wireless communication apparatus. The navigation apparatus includes GPS synchronization means, assistance data output means, and first control means. The GPS synchronization means performs a GPS synchronization to receive assistance data (e.g., almanac data, ephemeris data) from a GPS satellite. The assistance data output means outputs the assistance data to the wireless communication apparatus. When the navigation apparatus is on, the first control means causes the GPS synchronization means to perform the GPS synchronization and causes the assistance data output means to output the first assistance data to the wireless communication apparatus. The wireless communication apparatus includes assistance data input means, second control mean, start signal output means, GPS positioning means, and result data transmission means. The assistance data input means receives the assistance data from the navigation apparatus. The second control mean includes memory means for storing the assistance data. The start signal output means outputs a start signal to the GPS positioning means, for example, when an abnormal condition of the vehicle is detected. The GPS positioning means performs a GPS positioning to calculate a current location of the vehicle. The data transmission means transmits location data indicative of the current location of the vehicle to a predetermined destination.

When the navigation apparatus is off, the second control means causes the GPS positioning means to perform the GPS positioning by using the assistance data in response to the start signal so that a warm start or a hot start of the GPS positioning can be provided. In such an approach, the location data can be transmitted to the predetermined destination, as soon as the abnormal condition of the vehicle occurs. There is no need of continuously performing the GPS synchronization so that power consumption of a battery of the vehicle can be reduced. Further, there is no need of using network assistance so that there is no need of developing an infrastructure for the network assistance.

### BRIEF DESCRIPTION OF THE DRAWINGS

The above and other objectives, features and advantages of the present invention will become more apparent from the following detailed description made with reference to the accompanying drawings. In the drawings:

FIG. 1 is a block diagram of an in-vehicle communication system according to an embodiment of the present invention; and

FIG. 2A is a flow chart of a vehicle navigation apparatus in the communication system of FIG. 1, and FIG. 2B is a flow chart of an emergency report apparatus in the communication system of FIG. 1.

### DETAILED DESCRIPTION OF THE PREFERRED EMBODIMENT

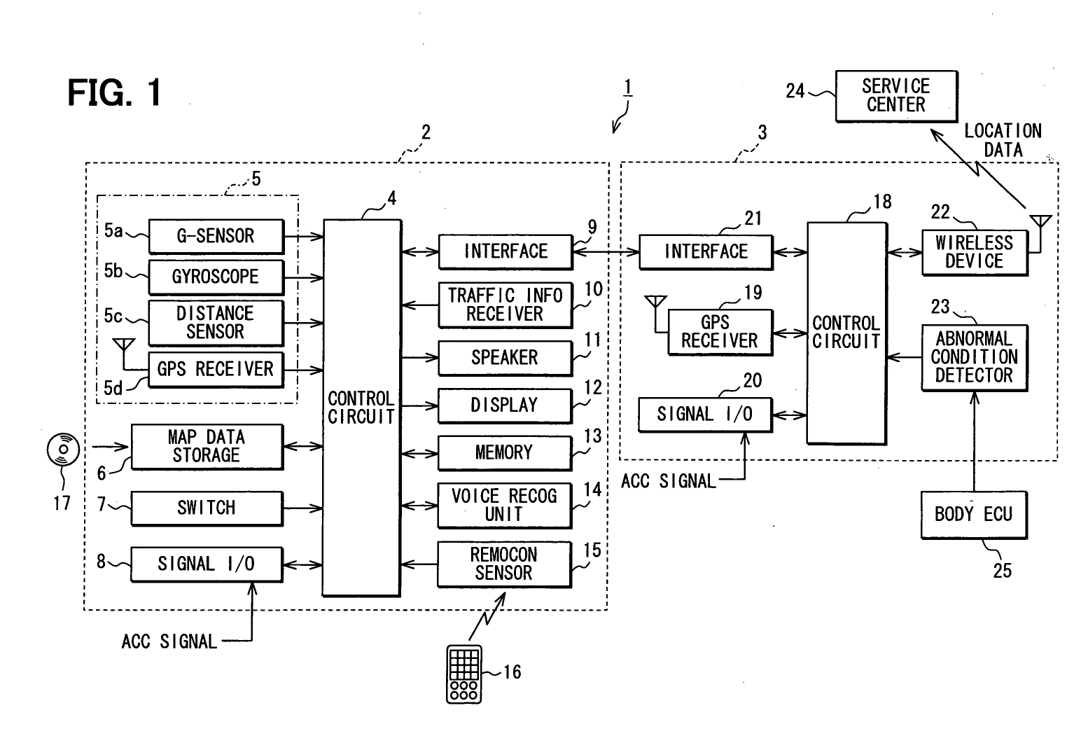

As shown in FIG. 1, a wireless communication system 1 according to a first embodiment of the present invention includes a vehicle navigation apparatus 2 and an emergency report apparatus 3.

The navigation apparatus 2 includes a first control circuit 4 acting as first control means, a position sensor 5, a map data storage 6, a functional switch 7, a first vehicle signal input/output (I/O) 8, a first interface 9 acting as assistance data output means, a traffic information receiver 10, a speaker 11, a display unit 12, a memory 13, a voice recognition unit 14, a remote control (remocon) sensor 15, and a remote control unit 16.

The first control circuit 4 includes a central processing unit (CPU), a read only memory (ROM), a random access memory (RAM), and an I/O interface, which are connected to each other via a bus. The first control circuit 4 controls overall operation of the navigation apparatus 2.

The position sensor 5 includes a gravity sensor (G-sensor) 5a, a gyroscope 5b, a distance sensor 5c, and a first global positioning system (GPS) receiver 5d acting as first GPS synchronization means. The first GPS receiver 5d of the position sensor 5 performs a GPS synchronization to receive assistance data from a GPS satellite. The assistance data includes almanac data, ephemeris data, previously detected location data, or the like. Each of the G-sensor 5a, the gyroscope 5b, the distance sensor 5c, and the first GPS receiver 5d has a different kind of a measurement error. Sensor signals from the G-sensor 5a, the gyroscope 5b, the distance sensor 5c, and the first GPS receiver 5d are sent to the first control circuit 4 and complement each other so that the measurement error can be corrected. Thus, the first control circuit 4 and the position sensor 5 work in conjunction with each other to detect current location, travel direction, speed, and travel distance of a vehicle. Alternatively, the position sensor 5 may not include at least one of the G-sensor 5a, the gyroscope 5b, the distance sensor 5c, and the first GPS receiver 5d, as long as the position sensor 5 can detect the current location of the vehicle with required precision and accuracy. Alternatively, the position sensor 5 may further include a steering wheel sensor, a steering wheel rotation sensor, a wheel speed sensor, and/or the like.

The map data storage 6 stores map data, which is loaded from a storage media 17 such as a DVD-ROM, a hard disk drive, a memory card, or the like. The functional switch 7 includes a mechanical switch arranged around a screen of the display unit 12 and a touch switch appearing on the screen of the display unit 12. The first vehicle signal I/O 8 receives an accessory (ACC) signal from a vehicle ACC switch acting as a predetermined switch. The ACC switch is turned on and outputs the ACC signal to the first vehicle signal I/O 8, when an ignition switch of the vehicle is in ACC position, or ON position.

The first interface 9 acts as an interface to the emergency report apparatus 3. The first control circuit 4 outputs the assistance data, which is received by the first GPS receiver 5d as the result of the GPS synchronization, to the emergency report apparatus 3 via the first interface 9.

The traffic information receiver 10 receives traffic and travel information from outside. For example, the traffic information receiver 10 may be a traffic message channel (TMC) receiver, a vehicle information and communication system (VICS) receiver, or the like. TMC and VICS are technologies used in Europe and Japan, respectively, for delivering traffic and travel information to drivers. The speaker 11 produces sound, for example, for voice navigation from the current location to destination. The display unit 12 displays a road map corresponding to the map data stored in the map data storage 6. A swept path and current location of the vehicle are shown on the road map displayed on the display unit 12. The display unit 12 may be, for example, a color liquid crystal display (LCD), organic light emitting (EL) display, plasma display, or the like.

The memory 13 may be, for example, a detachable flash memory card. The memory 13 stores photo data, music data, and the like. The display unit 12 displays the photo data and the speaker 11 produces sound corresponding to the music data. The voice recognition unit 14 implements the voice navigation and includes a microphone and a processing circuit. The microphone picks up a user's voice and the processing circuit analyzes the voice based on a predetermined voice recognition algorithm. The remote control sensor 15 receives a control signal emitted from the remote control unit 16 and outputs the received control signal to the first control circuit 4.

The emergency report apparatus 3 includes a second control circuit 18 acting as second control means, a second GPS receiver 19 acting as second GPS synchronization means, a second vehicle signal I/O 20, a second interface 21 acting as assistance data input means, a wireless communication device 22 acting as result data transmission means, and an abnormal condition detector 23 acting as a start signal output means.

The second control circuit 18 includes a CPU, a ROM, a RAM, and an I/O interface, which are connected to each other via a bus. The second control circuit 18 controls overall operation of the emergency report apparatus 3.

The second GPS receiver 19 performs a GPS positioning in response to a positioning command from the second control circuit 18 and outputs a GPS positioning result to the second control circuit 18. The second vehicle signal I/O 20 receives the ACC signal from the ACC switch of the vehicle. The second interface 21 acts as an interface to the navigation apparatus 2. The second control circuit 18 receives the assistance data from the navigation apparatus 2 via the second interface 21.

The wireless communication device 22 establishes and terminates connection to a service center (server) 24 in response to a control command from the second control circuit 18. The abnormal condition detector 23 is connected to an anti-theft sensor (e.g., a vibration sensor, a door sensor) via a body electronic control unit (ECU) 25. When the anti-theft sensor detects vibration or opening of the door, the anti-theft sensor outputs a detection signal to the body ECU 25. When the body ECU 25 receives the detection signal from the anti-theft sensor, the body ECU 25 outputs an abnormal condition signal to the abnormal condition detector 23.

The communication system 1 operates as follows:

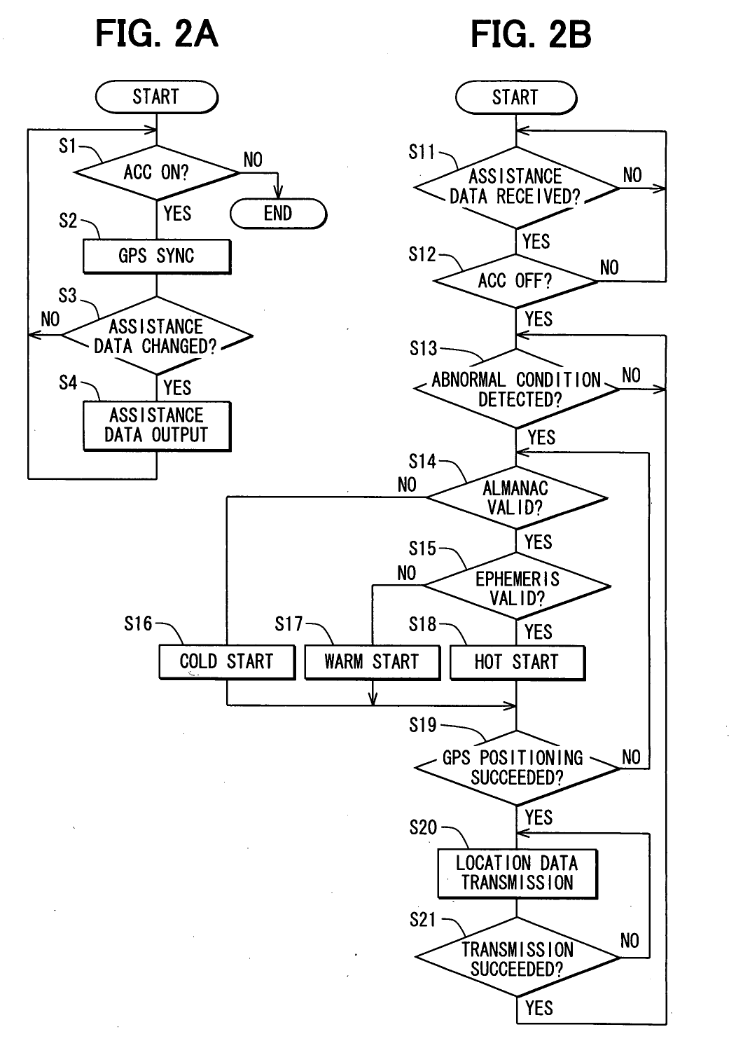

The first control circuit 4 of the navigation apparatus 2 performs a first process shown in a flow chart of FIG. 2A. The first process starts with step S1, where the first control circuit 4 determines based on the ACC signal, which is received from the ACC switch via the first vehicle signal I/O 8, whether the ACC switch is on or off. If the first control circuit 4 determines that the ACC switch is off, the first process is ended. In contrast, if the first control circuit 4 determines that the ACC switch is on, the first process proceeds to step S2, where the first control circuit 4 instructs the position sensor 5 to perform the GPS synchronization. As the result of the GPS synchronization, the first GPS receiver 5d of the position sensor 5 receives a GPS signal and decodes the received GPS signal to the assistance data, which includes the almanac data, ephemeris data, and the like.

Then, the first process proceeds to step S3, where the first control circuit 4 determines whether there is a difference between current and previous assistance data. In short, the first control circuit 4 determines whether there is a change in the assistance data. The assistance data changes as the location of the vehicle changes. If the first control circuit 4 determines that there is no change in the assistance data, the first process returns to step S1. In contrast, if the first control circuit 4 determines that there is the change in the assistance data, the first process proceeds to step S4, where the first control circuit 4 outputs the current assistance data via the first interface 9. Thus, every time the assistance data changes due to the change in the location of the vehicle, the navigation apparatus 2 outputs the latest assistance data to the emergency report apparatus 3 during a period of time when the ACC switch is on.

The second control circuit 18 of the emergency report apparatus 3 performs a second process shown in a flow chart of FIG. 2B. The second process starts with step S11, where the second control circuit 18 determines whether to receive the assistance data from the navigation apparatus 2 via the second interface 21. If the second control circuit 18 receives no assistance data, the second process repeats step S11. In contrast, if the second control circuit 18 receives the assistance data, the second control circuit 18 stores the received assistance data in a predetermined memory area (e.g., RAM) or updates old assistance data previously stored in the memory area with currently received assistance data. Thus, the memory area always stores the latest assistance data.

Then, the second process proceeds to step S12, where the second control circuit 18 determines based on the ACC signal, which is received from the ACC switch via the second vehicle signal I/O 20, whether the ACC switch is on or off. If the second control circuit 18 determines that the ACC switch is off, the second process returns to step S11. In contrast, if the second control circuit 18 determines that the ACC switch is on, the second process proceeds to step S13.

At step S13, the second control circuit 18 determines based on the abnormal condition signal, which is received from the body ECU 25 via the abnormal condition detector 23, whether the vehicle is in an abnormal condition. If the second control circuit 18 determines that the vehicle is in a normal condition, the second process repeats step S13. In contrast, if the second control circuit 18 determines that the vehicle is in the abnormal condition, the second process proceeds to step S14.

At step S14, the second control circuit 18 reads the latest assistance data from the memory area and determines whether the almanac data is valid or invalid by checking time information contained in the almanac data. For example, the second control circuit 18 determines that the almanac data is valid if the time information represents the time within one month from the current time. In short, the almanac data is valid for one month.

At step S14, if the second control circuit 18 determines that the almanac data is invalid, the second process proceeds to step S16, where a cold start of the second GPS receiver 19 is executed. Specifically, the second control circuit 18 instructs the second GPS receiver 19 to perform the GPS synchronization to receive both new almanac data and new ephemeris data. The second GPS receiver 19 performs the GPS positioning by using the new almanac data and the new ephemeris data. Therefore, the second GPS receiver 19 performs the GPS positioning without using the assistance data that is received from the navigation apparatus 2 and stored in the memory area.

In contrast, at step S14, if the second control circuit 18 determines that the almanac data is valid, the second process proceeds to step S15. At step S15, the second control circuit 18 determines whether the ephemeris data is valid or invalid by checking time information contained in the ephemeris data. For example, the second control circuit 18 determines that the ephemeris data is valid if the time information represents the time within two hours from the current time. In short, the ephemeris data is valid for two hours.

At step S15, if the second control circuit 18 determines that the ephemeris data is invalid, the second process proceeds to step S17, where a warm start of the second GPS receiver 19 is executed. Specifically, the second control circuit 18 instructs the second GPS receiver 19 to perform the GPS synchronization to receive only new ephemeris data from the GPS satellite. The second GPS receiver 19 performs the GPS positioning by using the almanac data, which is received from the navigation apparatus 2 and stored in the memory area, and the new ephemeris data, which is received by the second GPS receiver 19 from the GPS satellite. The time required for the warm start is shorter than the time required for the cold start, because new almanac data is not received from the GPS satellite in the warm start.

In contrast, at step S15, if the second control circuit 18 determines that the ephemeris data is valid, the second process proceeds to step S18, where a hot start of the second GPS receiver 19 is executed. Specifically, the second control circuit 18 instructs the second GPS receiver 19 to perform the GPS positioning by using the almanac and ephemeris data stored in the memory area. The time required for the hot start is shorter than the time required for the warm start, because the second GPS receiver 19 does not the GPS synchronization in the hot start.

After step S16, S17, or S18, the second process proceeds to step S19 whether the second control circuit 18 determines whether the GPS positioning succeeds or fails. If the second process determines that the GPS positioning fails, the second process returns to step S14. In contrast, the second process determines that the GPS positioning succeeds, the second process proceeds to step S20.

At step S20, the second control circuit 18 instructs the wireless communication device 22 to establish the connection to the service center 24 and transmits the GPS positioning result (i.e., location data indicative of the current location of the vehicle) to the service center 24 via the wireless communication device 22.

Then, the second process proceeds to step S21, where the second control circuit 18 determines whether the transmission of the GPS positioning result to the service center 24 succeeds or fails. If the second control circuit 18 determines that the transmission of the GPS positioning result fails, the second process returns to step S20. In contrast, if the second control circuit 18 determines that the transmission of the GPS positioning result succeeds, the second process returns to step S13.

In the communication system 1 according to the embodiment, the emergency report apparatus 3 receives the assistance data from the navigation apparatus 2. The assistance data includes the almanac and ephemeris data used for the GPS positioning. The assistance data is stored in the memory area such as the ROM in the second control circuit 18. The assistance data stored in the memory area is updated, every time when the emergency report apparatus 3 receives the assistance data from the navigation apparatus 2.

When the anti-theft sensor such as the vibration sensor or the door sensor detects the abnormal condition of the vehicle, the second control circuit 18 determines whether the assistance data stored in the memory area is valid or invalid. If the assistance data stored in the memory area is valid, the second GPS receiver 19 of the emergency report apparatus 3 starts to perform the GPS positioning by using the valid assistance data stored in the memory area. In short, the warm start or the hot start of the second GPS receiver 19 is executed by using the valid assistance data stored in the memory area so that the cold start of the second GPS receiver 19 can be prevented. In such an approach, the emergency report apparatus 3 can transmit the location data indicative of the current location of the vehicle to the service center 24, as soon as the abnormal condition of the vehicle occurs. The second GPS receiver 19 performs the GPS synchronization to receive the assistance data from the GPS satellite, only when the assistance data stored in the memory area is invalid. Therefore, there is no need that the second GPS receiver 19 continuously performs the GPS synchronization during the period of time when the ACC switch is off. Thus, power consumption of a battery of the vehicle can be reduced so that the battery can be prevented from overdischarging, when the vehicle is parked. Further, since the communication system 1 does not use network assistance, there is no need of developing an infrastructure for the network assistance.

(Modifications)

The embodiment described above may be modified in various ways. For example, if the second process determines that the GPS positioning fails at step S19, the second control circuit 18 may send an error message to the service center 24 to inform the service center 24 of the failure of the GPS positioning. In stead of the emergency report apparatus 3, the communication system 1 may include a wireless communication apparatus that performs the GPS positioning and transmits the GPS positioning result to the service center 24 in response to a request signal from the service center 24.

Such changes and modifications are to be understood as being within the scope of the present invention as defined by the appended claims.

What is claimed is:

1. A communication system for a vehicle comprising:
a navigation system including first GPS synchronization means, assistance data output means, and a first control means, the first GPS synchronization means performing first GPS synchronization to receive first assistance data from a GPS satellite, the assistance data output means outputting the first assistance data, the first control means causing the first GPS synchronization means to perform the first GPS synchronization when a predetermined switch is in a on position and causing the assistance data output means to output the first assistance data when the predetermined switch is in the on position; and
a wireless communication apparatus including assistance data input means, a second control means, start signal output means, GPS positioning means, result data transmission means, the assistance data input means receiving the first assistance data from the navigation system, the second data control means including memory means for storing the first assistance data, the start signal output means outputting a start signal to the GPS positioning means, the GPS positioning means performing GPS positioning to calculate a current location of the vehicle, the result data transmission means transmitting result data indicative of a result of the GPS positioning to a predetermined destination, wherein
the second control means causes the GPS positioning means to perform the GPS positioning by using the first assistance data in response to the start signal, when the predetermined switch is in a off position.

2. The communication system according to claim 1, wherein
the wireless communication apparatus further includes second GPS synchronization means for performing a second GPS synchronization to receive second assistance data from the GPS satellite,
the second control means further includes validity determination means determining whether the first assistance data stored by the memory means is valid for the GPS positioning, and
when the first assistance data is invalid, the second control means causes the second GPS synchronization means to perform the second GPS synchronization and causes the GPS positioning means to perform the GPS positioning by using the second assistance data.

3. The communication system according to claim 1, wherein
the start signal output means includes detection means for detecting an abnormal condition of the vehicle, the start signal output means outputting the start signal to the GPS positioning means upon detection of the abnormal condition.

4. A wireless communication apparatus used in a communication system for a vehicle, the communication system having a vehicle navigation apparatus that performs a GPS synchronization to receive first assistance data from a GPS satellite when a predetermined switch is on and that outputs the first assistance data to the wireless communication apparatus when the predetermined switch is in a on position, the wireless communication apparatus comprising:
assistance data input means for receiving the first assistance data from the navigation apparatus;
control means including memory means for storing the first assistance data;
GPS positioning means for performing a GPS positioning to calculate a current location of the vehicle;
start signal output means for outputting a start signal to the GPS positioning means; and
result data transmission means for transmitting result data indicative of a result of the GPS positioning to a predetermined destination, wherein
the control means causes the GPS positioning means to perform the GPS positioning by using the first assistance data in response to the start signal, when the predetermined switch is in a off position.

5. The wireless communication apparatus according to claim 4, further comprising:
second GPS synchronization means for performing second GPS synchronization to receive second assistance data from the GPS satellite, wherein
the control means further includes validity determination means for determining whether the first assistance data stored by the memory means is valid for the GPS positioning, and
when the first assistance data is invalid, the control means causes the second GPS synchronization means to perform the second GPS synchronization and causes the GPS positioning means to perform the GPS positioning by using the second assistance data.

6. A wireless communication method for a vehicle comprising:
receiving first assistance data from a navigation apparatus in the vehicle, when the navigation apparatus is on;
storing the first assistance data;
detecting abnormal condition of the vehicle;
calculating a current location of the vehicle by using the first assistance data upon detection of the abnormal condition, when the navigation system is off; and
transmitting location data indicative of the current location of the vehicle to a predetermining destination.

7. The method according to claim 6, further comprising:
determining whether the first assistance data is valid for the calculation of the current location of the vehicle; and
receiving second assistance data from a GPS satellite, wherein the calculating step calculates the current location of the vehicle by using the second assistance data, when the first assistance data is invalid.
